(19) United States
(12) Patent Application Publication
(10) Pub. No.: US 2009/0185087 A1
(43) Pub. Date: Jul. 23, 2009

(54) LIQUID CRYSTAL DISPLAY AND HEAD-UP DISPLAY

(75) Inventor: Masatoshi SATO, Hashima-shi (JP)

Correspondence Address: OLIFF & BERRIDGE, PLC, P.O. BOX 320850, ALEXANDRIA, VA, 22320-4850, US

(73) Assignee: EPSON IMAGING DEVICES CORPORATION, AZUMINO-SHI (JP)

(21) Appl. No.: 12/326,383

(22) Filed: Dec. 2, 2008

(30) Foreign Application Priority Data
Jan. 23, 2008 (JP) 2008-012207

(51) Int. Cl. G09G 3/36; G02F 1/13357; G02F 1/1333

(52) U.S. Cl. 349/11; 345/102

(57) ABSTRACT

A liquid crystal display device includes: pixels which each include a liquid crystal, a pixel electrode, and a common electrode, the pixel electrode and the common electrode applying voltage to the liquid crystal; a display unit in which the plurality of pixels are arranged in a matrix shape; and a plurality of light sources. The voltage applied to the liquid crystal is adjusted by varying an intensity of voltage applied to the common electrode of the pixels in accordance with light radiated by the plurality of light sources.

### CROSS-REFERENCE TO RELATED APPLICATION

This application claims priority from Japanese Patent Application No. 2008-012207, filed in the Japanese Patent Office on Jan. 23, 2008, the entire disclosure of which is hereby incorporated by reference in its entirety.

### BACKGROUND

1. Technical Field

The present invention relates to a liquid crystal display and a head-up display, and particularly to a field sequential driving liquid crystal display device and a head-up display capable of radiating plural light sources in succession.

2. Related Art

In the past, there was known a field sequential driving liquid crystal display device capable of allowing a plurality of light sources to radiate light in succession (for example, see JP-A-2002-148584).

JP-A-2002-148584 discloses a liquid crystal display device which includes an A/D converter converting red (R), green (G), and blue (B) analog signals into digital signals, an inverse gamma correction circuit, a gamma correction circuit, and a level correction circuit varying an intensity level of the digital signals. However, when a bend-alignment cell with a high response speed is used, the bend-alignment cell has characteristics in which a relation between voltage applied to a liquid crystal and a transmissivity depends on the wavelength of radiation light. Therefore, even when certain voltage is applied to the liquid crystal in order to exhibit a black display, for example, it is difficult to exhibit the original black display since the transmissivity depends on the wavelength of the radiation light. In order to solve this problem, JP-A-2002-148584 achieves a target transmissivity or a target reflectance by varying intensity levels of RGB digital signal in every RGB and varying voltage applied to liquid crystal in every RGB by level correction circuits (an inverse gamma correction circuit and a gamma correction circuit).

In the liquid crystal display device disclosed in JP-A-2002-148584, however, a process of correcting the RGB digital signal is performed plural times by both the inverse gamma correction circuit and the gamma correction circuit. For that reason, a problem may occur in that the configuration of the liquid crystal display device is complicated.

### SUMMARY

An advantage of some aspects of the invention is that it provides a liquid crystal display device capable of displaying a black color while simplifying the configuration of the liquid crystal display device.

According to an aspect of the invention, there is provided a liquid crystal display device including: pixels which each include a liquid crystal, a pixel electrode, and a common electrode, the pixel electrode and the common electrode applying voltage to the liquid crystal; a display unit in which the plurality of pixels are arranged in a matrix shape; and a plurality of light sources. The voltage applied to the liquid crystal is adjusted by varying an intensity of voltage applied to the common electrode of the pixels in accordance with light radiated by the plurality of light sources.

The liquid crystal display device having the above-described configuration varies the intensity of the voltage applied to the common electrode of pixels in the above-mentioned manner to adjust black voltage of the pixels. Therefore, since the black voltage of the pixels is adjusted with only one process of varying the intensity of the voltage applied to the common electrode of the pixels, it is possible to display a black color while simplifying the configuration of the liquid crystal display device, compared to a configuration in which a plurality of processes are performed. For example, when red, green, and blue light sources are provided, it is possible to surely display the black color at locations where the black color is displayed by adjusting the black voltage of the respective colors.

In the liquid crystal display device having the above-described configuration, the intensity of the voltage applied to the common electrode of the pixels may vary in each color of the plurality of light sources, so that transmissivities of a black display, where transmissivity of the pixels is the minimum, in the colors of the plurality of light sources are adjusted to be substantially equal to each other. With such a configuration, amounts of transmitted light of the plurality of light sources are substantially equal to each other. Therefore, it is possible to display the black color with the plurality of light sources for red, green, and blue colors, for example.

In the liquid crystal display device having the above-described configuration, the voltage applied to the common electrode may be in a pulse state. With such a configuration, it is possible to drive the liquid crystal display device using the voltage having the same amplitude as that of the pulse of the voltage applied to the common electrode by allowing the voltage applied to the pixel electrodes to become the reverse polarity pulse state of the voltage applied to the common electrode. In this way, the amplitude of the pulse of the voltage applied to the pixel electrodes is decreased, compared to a case where voltage is applied to the plus side and minus side of the respective pixel electrodes with reference to the voltage applied to the common electrode like DC voltage applied to the common electrode. Accordingly, it is possible to reduce the power consumption of the liquid crystal display device.

In the liquid crystal display device having the above-described configuration, the liquid crystal may exhibit a bend alignment in which liquid crystal molecules of the liquid crystal are arranged like a bow shape, when voltage for phase transition of the liquid crystal is applied. With such a configuration, the liquid crystal display device can realize a rapid response speed, since variation in the alignment of the liquid crystal molecules is accelerated in accordance with the bend alignment in accordance with a bow shape.

In the liquid crystal display device having the above-described configuration, the pixels may be of an inversion-driven type in which a polarity of the voltage applied to the liquid crystal is changed by varying the voltage applied to the common electrode of the pixels whenever the light sources radiating light are switched. With such a configuration, it is possible to prevent image sticking of the liquid crystal from occurring, since a direction of the voltage applied to the liquid crystal varies whenever the light source is changed.

In the liquid crystal display device having the above-described configuration, respective colors radiated by the plurality of light sources may be different colors selected from red, green, and blue. With such a configuration, it is possible to display red, green, and blue colors and various colors by additive color mixing.

In the liquid crystal display device having the above-described configuration, the intensity of voltage applied to the pixel electrodes of the pixels may vary in each color of the plurality of light sources, so that the maximum transmissivities of the pixels in the colors of the plurality of light sources are adjusted to be substantially equal to each other. With such a configuration, it is possible to display a white color by using the plurality of red, green, and blue light sources, for example, since transmitted light amounts of the plurality of light sources are substantially equal to each other.

The liquid crystal display device having the above-described configuration may further include a first circuit to which reference voltage is applied and which converts a digital image signal to an analog image signal and applies voltage to the pixel electrodes; and a second circuit which is disposed between a power source generating the reference voltage and the first circuit. The intensity of the voltage applied to the pixel electrodes varies by adding the voltage applied to the common electrode to the reference voltage. With such a configuration, it is possible to easily vary the intensity of the voltage applied to the pixel electrodes using the voltage applied to the common electrode.

In the liquid crystal display device having the first circuit and the second circuits, the second circuit may be composed of a non-inverting amplifier. With such a configuration, it is possible to easily increase the voltage output the second circuit by adding the voltage applied to the common electrode to the reference voltage output to the second circuit.

According to another aspect of the invention, there is provided a head-up display including the liquid crystal display device having the above-described configuration. With such a configuration, it is possible to realize the head-up display capable of display the black color while simplifying the configuration of the liquid crystal display device.

### BRIEF DESCRIPTION OF THE DRAWINGS

The invention will be described with reference to the accompanying drawings, wherein like numbers reference like elements.

FIG. 1 is a block diagram illustrating the entire configuration of a field sequential liquid crystal display device according to a first embodiment of the invention.

FIG. 2 is a diagram illustrating the configuration of pixels according to the first embodiment of the invention.

FIG. 3 is an explanatory diagram illustrating an inverse driving process of the field sequential liquid crystal display device according to the first embodiment of the invention.

FIG. 4 is a diagram illustrating a waveform of voltage applied to a common electrode and pixel electrodes according to the first embodiment of the invention.

FIG. 5 is a diagram illustrating the waveform of the voltage applied to the common electrode and the pixel electrodes according to the first embodiment of the invention.

FIG. 6 is a diagram illustrating a relation between voltage applied to a liquid crystal and a transmissivity according to the first embodiment of the invention.

FIG. 7 is a diagram illustrating a head-up display equipped with the liquid crystal display device according to the first embodiment of the invention.

FIG. 8 is an explanatory diagram illustrating the head-up display equipped with the liquid crystal display device according to the first embodiment of the invention.

FIG. 9 is a diagram illustrating a circuit varying white voltage in a field sequential liquid crystal display device according to a second embodiment of the invention.

### DESCRIPTION OF EXEMPLARY EMBODIMENTS

Hereinafter, preferred embodiments of the invention will be described with reference to the drawings.

### First Embodiment

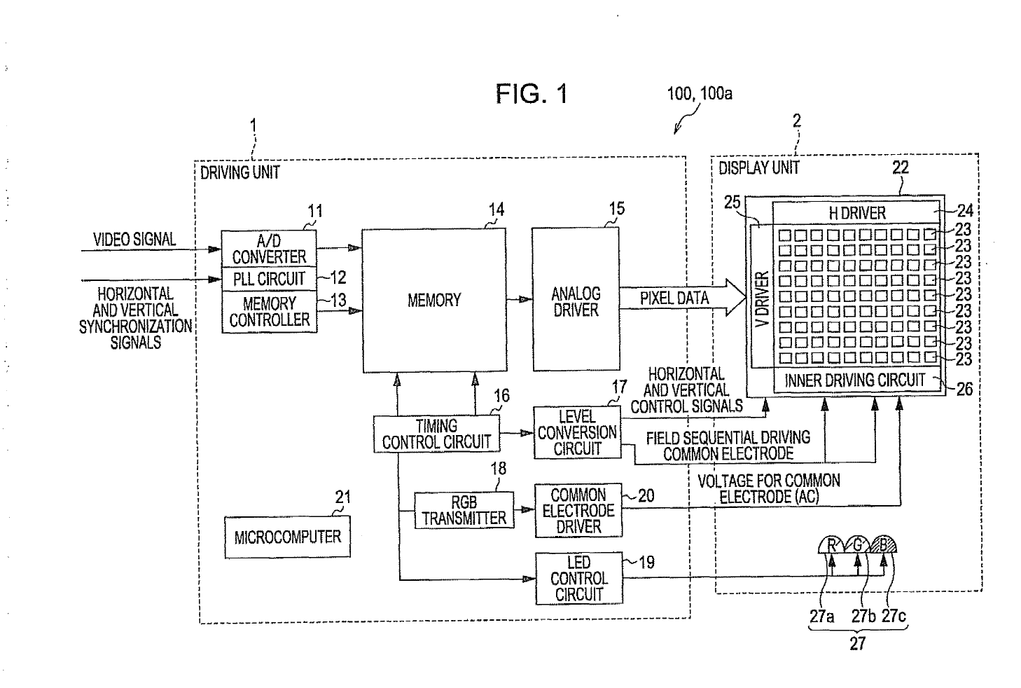

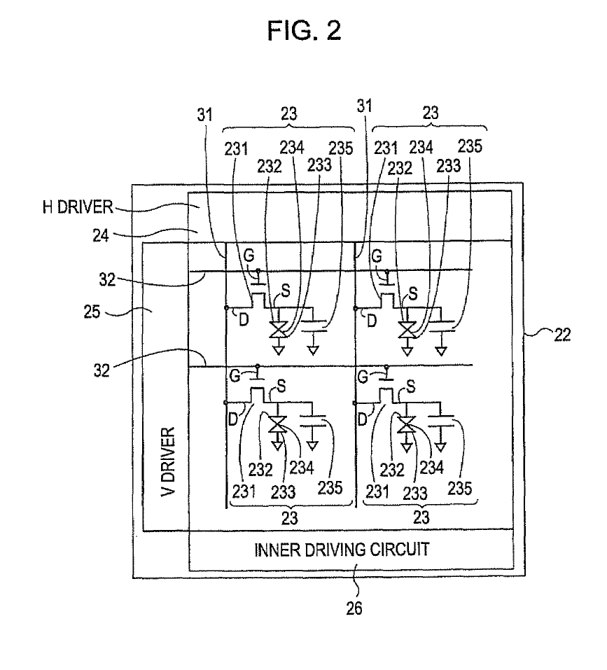

FIG. 1 is a block diagram illustrating the entire configuration of a field sequential liquid crystal display device according to a first embodiment of the invention. FIG. 2 is a diagram illustrating the configuration of pixels according to the first embodiment of the invention. First, the configuration of a field sequential liquid crystal display device 100 will be described with reference to FIGS. 1 and 2 according to the first embodiment. In addition, in the first embodiment, the invention is applied to the field sequential liquid crystal display device 100 which is an example of a liquid crystal display device.

According to the first embodiment, the field sequential liquid crystal display device 100 includes a driving unit 1 and a display unit 2, as shown in FIG. 1. Hereinafter, the detailed configuration will be described,

As shown in FIG. 1, the driving unit 1 includes an A/D converter 11, a PLL (phase synchronization) circuit 12, a memory controller 13, a memory 14, an analog driver 15, a timing control circuit 16, a level conversion circuit 17, an RGB transmitter 18, an LED control circuit 19, a common electrode driver 20, and a microcomputer 21.

The A/D converter 11, the PLL circuit 12, and the memory controller 13 are connected to each other. The A/D converter 11 converts analog video signals into R (read), G (green), and B (blue) digital signals. The PLL circuit 12 generates a clock to be written to the memory 14 from a horizontal synchronization signal and generates a clock necessary for performing a field sequential driving process. The memory controller 13 generates a timing signal used to store the analog video signals converted into the RGB digital signals in the memory 14 in every RGB and generates a call timing signal necessary for performing the field sequential driving process.

The A/D converter 11 and the memory 14 are connected to each other. The memory controller 13 and the memory 14 are connected to each other. The memory 14 stores the RGB digital signals,

The memory 14 and the analog driver 15 are connected to each other. The analog driver 15 converts the RGB digital signals into the RGB analog signals and supplies the RGB analog signals to the display unit 2.

The timing control circuit 16 is connected to the memory 14, the level conversion circuit 17, the REGB transmitter 18, and the LED control circuit 19. The timing control circuit 16 generates a signal used to drive pixels 23 described below. The level conversion circuit 17 generates pulses (horizontal and vertical control signals and a field sequential driving control signal) used to drive the pixels 23. The RGB transmitter 18 is connected to the common electrode driver 20 and transmits a signal for voltage applied to a common electrode 233 described below to the common electrode driver 20 in every signal of red (R), green (G), and blue (B) images. The common electrode driver 20 determines the voltage applied to the common electrode 233 to supply the voltage to the pixel 23. The LED control circuit 19 controls an LED 27 to radiate light and stop radiating light at timing of the field sequential driving process.

The microcomputer 21 is connected to all the circuits included in the driving unit 1 and controls all operations of the driving unit 1.

As shown in FIG. 1, a display unit 2 includes a substrate 22, a plurality of pixels 23, an H driver 24 connected to the plurality of pixels connected to the plurality of pixels 23, a V driver 25 connected to the plurality of pixels, and an inner driving circuit 26 driving the H driver 24 and the V driver 25, and the LED 27. The LED 27 is an example of “a light source” in the invention. According to the first embodiment, the LED 27 includes LEDs 27a to 27c radiating red (RB), green (G), and blue (B) light, respectively.

As shown in FIG. 2, a plurality of signal Lines 31 and a plurality of scanning lines 32 are arranged on the substrate 22 to be perpendicular to each other. The signal lines 31 are connected to the H driver 24 and the scanning lines 32 are connected to the V driver 25. The pixels 23 are disposed at locations where the signal lines 31 and the scanning lines 32 intersect with each other. In FIG. 2, only four pixels are illustrated for simple illustration. Each of the pixels 23 includes an n-channel transistor 231, a pixel electrode 232, a common electrode 233 disposed opposite the pixel electrode 232, a liquid crystal 234 interposed between the pixel electrode 232 and the common electrode 233, and a supplementary capacitor 235. According to the first embodiment, the liquid crystal 234 is an OCB (optically Compensated Bend) liquid crystal in which liquid crystal molecules of the liquid crystal 234 are arranged like a bow shape when voltage for phase transition of the liquid crystal 234 is applied. A drain area D of the n-channel transistor 231 is connected to the signal line 31 and a source area S is connected to the pixel electrode 232 and one electrode of the supplementary capacitor 235. In addition, a gate G of the n-channel transistor 231 is connected to the scanning line 32.

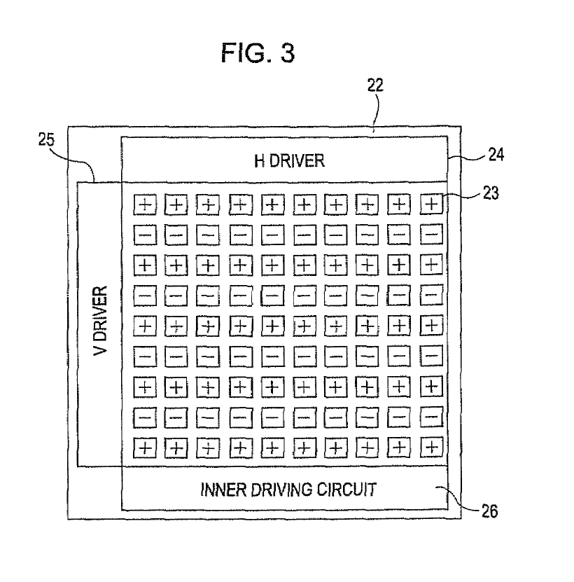

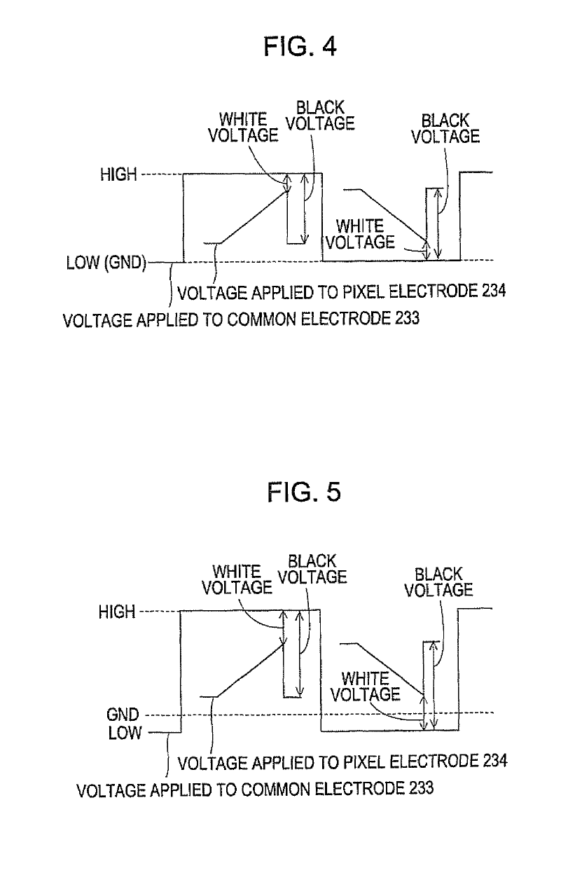

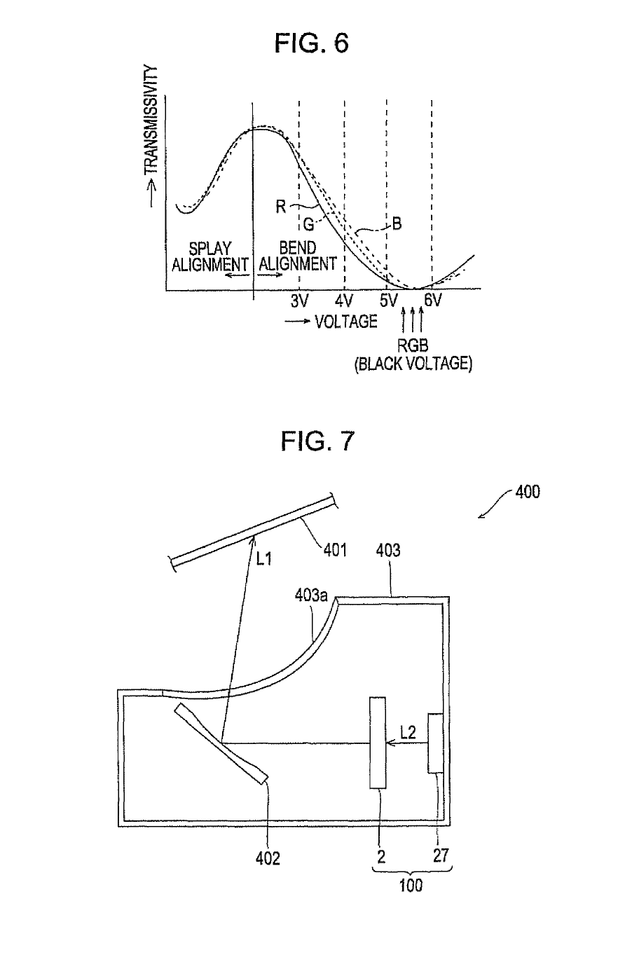

FIG. 3 is an explanatory diagram illustrating an inverse driving process of the field sequential liquid crystal display device according to the first embodiment of the invention. FIGS. 4 and 5 are diagrams illustrating a waveform of the voltage applied to the common electrode and the pixel electrodes according to the first embodiment of the invention. FIG. 6 is a diagram illustrating a relation between the voltage applied to the liquid crystal and a transmissivity according to the first embodiment of the invention. Next, the process of the field sequential liquid crystal display device 100 will be described with reference to FIG. 1 and FIGS. 3 to 6 according to the first embodiment of the invention.

As shown in FIG. 1, the analog video signals are first input to the A/D converter 11 and thus the analog video signals are converted into the RGB digital signals. In addition, horizontal vertical synchronization signals are input to the PLL circuit 12. The RGB digital signals are stored in the memory 14 at the timing signal generated by the memory controller 13 and stored in the memory 14 in every signal of the red, green, and blue colors.

The timing control circuit 16 generates a timing signal used to write RGB image data and a timing signal for the radiation of the LED 27. The horizontal and vertical control signals and the field sequential driving control signal are supplied to the display unit 2 through the level conversion circuit 17 on the basis of the timing signal generated by the timing control circuit 16. The RGB transmitter 18 transmits the signal for the voltage applied to the common electrode 233 (see FIG. 2) to the common electrode driver 20. According to the first embodiment, the intensity of the voltage applied to the common electrode 233 is different in every red (R), green (G), and blue (B) image data. The common electrode driver 20 supplies the voltage applied to the common electrode 233 to the display unit 2. The LED control circuit 19 controls the LED 27 to radiate light at timing of the field sequential driving process.

According to the first embodiment, as shown in FIG. 3, a line inverse driving process in which the voltage having different polarity, that is, positive (+) voltage and negative (−) voltage are applied to all rows is performed in the common electrode 233 (see FIG. 2) of the pixels 23 arranged in a matrix shape. According to the first embodiment, as shown in FIG. 4, the voltage applied to the common electrode 233 is pulse voltage In the voltage applied to the common electrode 233, high voltage (High) and low voltage (Low) are alternatively repeated. In addition, the low voltage (Low) is a ground (GND) voltage. The voltage applied to the pixel electrodes 232 are pulse voltage. The voltage applied to the pixel electrodes 232 is inversed as the voltage applied to the common electrode 233 is inversed from the high voltage (High) to the low voltage (Low). Voltage in which a difference between the voltage applied to the pixel electrodes 232 and the common electrode 233 is the maximum refers to black voltage. In addition, voltage in which a difference between the voltage applied to the pixel electrodes 232 and the common electrode 233 is the minimum refers to white voltage.

As shown in FIG. 6, the OCB liquid crystal varies from the splay alignment which is an initial molecule alignment to a bend alignment in which the liquid crystal molecules of the liquid crystal are arranged like a bow shape, upon enlarging the voltage (the difference between the voltage applied to the pixel electrodes 232 and the common electrode 233) applied to liquid crystal 234. In the OCB liquid crystal, the relation between the voltage applied to the liquid crystal 234 and the transmissivity of the pixels 23 is different in red (R), green (G), and blue (B) light. In an example shown in FIG. 6, the transmissivity decrease in an order of the blue (B), green (G), and red (R) light, when the voltage applied to the liquid crystal 234 is 4 V.

According to the first embodiment, the voltage in which the transmissivity of the pixels 23 is the minimum is the black voltage. As shown in FIG. 6, the black voltages of the red (R), green (G), and blue (B) light increase in an order of the red (R), green (G), and blue (B) light. Even when a predetermined voltage is applied to the liquid crystal 234 in order to display a black color, the black color is not displayed. That is because the transmissivities of the red (R), green (G), and blue (B) light are different from each other due to the different black voltages of the red (R), green (G), and blue (B) light.

According to the first embodiment, as shown in FIG. 5, the voltage applied to the common electrode 233 upon displaying a red (R) image is varied so that the amplitude of the pulse is increased more than the amplitude of the pulse shown in FIG. 4. That is, the voltage is increased more than the high voltage (High) and is decreased more than the low voltage (Low). In this way, the black voltage (which is the voltage in which a difference between the voltage applied to the pixel electrodes 232 and the common electrode 233 is the maximum) is changed. Even though not shown, in the voltage applied to the common electrode 233 upon displaying a green (G) image, the amplitude of the pulse shown in FIGS. 4 and 5 is changed. FIG. 4 shows the voltage applied to the common electrode 233 upon displaying a blue (B) image. By increasing the black voltage of the red (R) light, the black voltage of the red (R) light shown in FIG. 6 is moved toward the blue (B) light. Likewise, by increasing the black voltage of the green (G) light, the black voltage of the green (G) light shown in FIG. 6 is moved toward the blue (B) light. According to the first embodiment, the black voltages of the red (R), green (G), and blue (B) light are adjusted to be substantially equal to each other.

Next, operations of the field sequential liquid crystal display device 100 will be described when a black image is displayed on the display unit 2.

First, the positive (+) voltage is applied to the common electrode 233 of odd row (a first row, a third row, etc.) pixels 23 of the pixels 23 arranged in the matrix shape shown in FIG. 3. In addition, the negative (−) voltage is applied to the common electrode 233 of even row (a second row, a fourth row, etc.) pixels 23 of the pixels 23 arranged in the matrix shape. Subsequently, the red image is written to the pixels 23 of the display 2 in sequence by a signal from the analog driver 15. Then, the red LED 27a radiates light.

Next, the negative (−) voltage is applied to the common electrode 233 of the odd row pixels 23 of the pixels 23 arranged in the matrix shape. In addition, the positive (+) voltage is applied to the common electrode 233 of the even row pixels 23 of the pixels 23 arranged in the matrix shape. Subsequently, the green image is written to the pixels 23 of the display 2 in sequence by a signal from the analog driver 15. Then, the green LED 27b radiates light.

Next, the positive (+) voltage is applied to the common electrode 233 of the odd row pixels 23 of the pixels 23 arranged in the matrix shape. In addition, the negative (−) voltage is applied to the common electrode 233 of the even row pixels 23 of the pixels 23 arranged in the matrix shape. Subsequently, the blue image is written to the pixels 23 of the display 2 in sequence by a signal from the analog driver 15. Then, the blue LED 27c radiates light. By repeatedly performing the above-described operation, the field sequential liquid crystal display device 100 is driven.

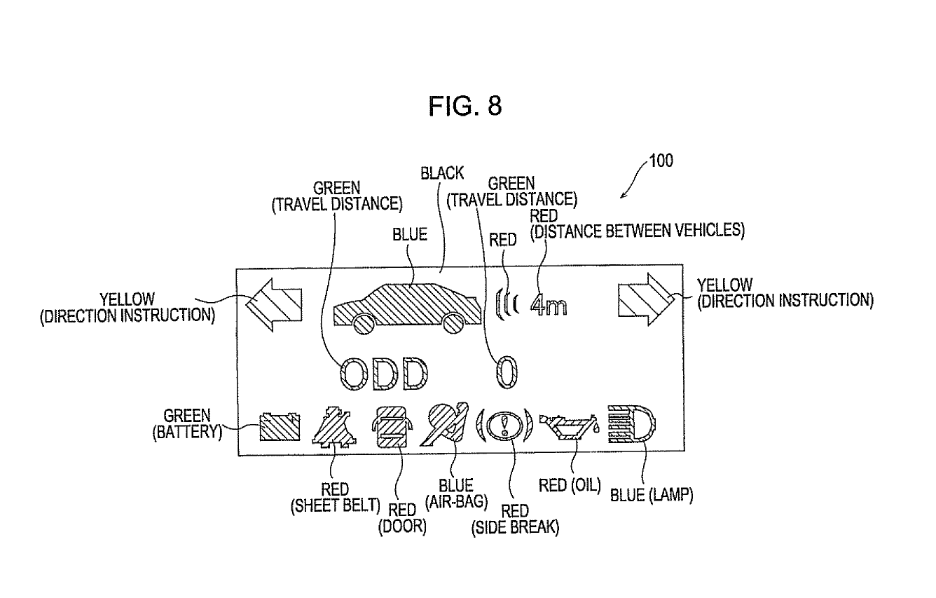

FIGS. 7 and 8 are diagrams illustrating a head-up display equipped with the liquid crystal display device according to the first embodiment of the invention. Next, a head-up display 400 equipped with the liquid crystal display device 100 will be described with reference to FIGS. 7 and 8 according to the first embodiment of the invention.

According to the first embodiment of the invention, as shown in FIG. 7, the liquid crystal display device 100 can be applied to the head-up display 400. The liquid crystal display device 100 is mounted in a predetermined apparatus capable of projecting display light L1 to a displaying object 401 (for example, a front glass of a vehicle). Specifically, the liquid crystal display device 100 includes the display unit 2 and the LED 27. The display unit 2 is disposed between the LED 27 and a concave mirror 402. The display light L1 output from the liquid crystal display device 100 is generated when light L2 from the LED 27 is incident on the display unit 2. The display light L1 output from the liquid crystal display device 100 is reflected from the concave mirror 402 toward the displaying object 401 to be projected to the displaying object 401. The above-described liquid crystal display device 100 and the concave mirror 402 are received within a case 403 having a window 403a projecting the display light L1. As shown in FIG. 8, such an in-vehicle head-up display 400 can be used to display information (for example, direction instruction, a distance between vehicles, a travel distance, various types of alarm information, information on roads or road guide, information on obstacles such as a person or an object) necessary for vehicle drive. A background color is a black color. Accordingly, the liquid crystal display device 100 according to the invention is capable of displaying the black display and thus is a liquid crystal display device appropriate for such a head-up display 400.

According to the first embodiment, the intensity of the voltage applied to the common electrode 233 of the pixels 23, as described above, to adjust the black voltage of the pixels 23. That is, the black voltage of the pixels 23 can be adjusted with only one process of varying the intensity of the voltage applied to the common electrode 233 of the pixels 23. Accordingly, it is possible to display the black color while simplifying the configuration of the liquid crystal display device 100, compared to a configuration in which a plurality of processes have to be performed.

According to the first embodiment, as described above, the light amounts of the plurality of LEDs 27a to 27c are made substantially equal to each other, by varying the intensity of the voltage applied to the common electrode 233 of the pixels 23 to adjust the transmissivities of the pixels 23 of the plurality of LEDs 27a to 27c to be substantially equal one another in every color of the plurality of LEDs 27a to 27c. It is possible to display the black color using the red LED 27a, the green LED 27b, and the blue LED 27c.

According to the first embodiment, the liquid crystal display device 100 can be driven by the voltage having the same amplitude as that of the pulse of the voltage applied to the common electrode 233 by allowing the voltage applied to the common electrode 233 and the voltage applied to the pixel electrodes 232 to become the pulse state, as described above. In this way, the amplitude of the pulse of the voltage applied to the pixel electrodes 232 is decreased, compared to a case where the voltage is applied to the plus side and minus side of the respective pixel electrodes 232 with reference to the voltage applied to the common electrode 233 like DC voltage applied to the common electrode 233. Accordingly, it is possible to reduce the power consumption of the liquid crystal display device 100.

According to the first embodiment, the liquid crystal 234 exhibits the bend alignment in which the liquid crystal molecules of the liquid crystal 234 are arranged like a bow shape when the voltage for the phase transition of the liquid crystal 234 is applied. With such a configuration, the variation in the alignment of the liquid crystal molecules is accelerated in accordance with the bent shape. Accordingly, the liquid crystal display device 100 capable of realizing the rapid response speed can be configured.

According to the first embodiment, the direction of the voltage applied to the liquid crystal 234 is varied in every switch of the radiating LED 27 by performing the inverse driving process of changing the polarity of the voltage applied to the common electrode 233 of the pixels 23 on the display unit 2 in every switch of the radiating LED 27, as described above. Accordingly, it is possible to prevent image-sticking of the liquid crystal 234 from occurring.

According to the first embodiment, the respective colors radiated from the LED 27 are different colors selected from red, green, and blue, as described above. Accordingly, it is possible to display red, green, and blue colors and various colors by additive color mixing.

According to the first embodiment, it is possible to easily realize the red, green, and blue light sources, by configuring the plurality of light sources as the LED 27, as described above.

### Second Embodiment

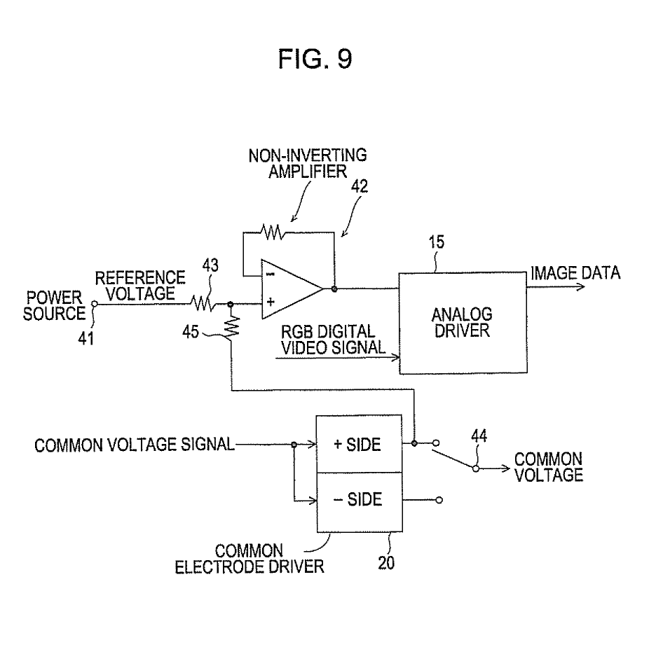

FIG. 9 is a diagram illustrating a circuit varying white voltage in a field sequential liquid crystal display device according to a second embodiment of the invention.

In the second embodiment, a field sequential liquid crystal display device 100a varying not only the black voltage but also the white voltage will be described with reference to FIG. 9, unlike the field sequential liquid crystal display device in the first embodiment.

As shown in FIG. 9, in the field sequential liquid crystal display device 100a according to the second embodiment, a non-inverting amplifier 42 is disposed between the analog driver 15 and a power source 41 generating a reference voltage for the analog driver 15. The analog driver 15 is an example of “a first circuit” of the invention. The power source 41 and one input terminal (+) of the non-inverting amplifier 42 are connected to each other via a resistor 43. An output side of the non-inverting amplifier 42 is connected to the analog driver 15. The common electrode driver 20 includes a circuit generating voltage of a plus side and a circuit generating voltage of a minus side and a common voltage signal is input to the circuits. A switch 44 is disposed on the output side of the common electrode driver 20 to be connected to the circuit generating the voltage of the plus side of the common electrode driver 20 or the circuit generating the voltage of the minus side thereof. Common voltage is applied to the common electrode 233 through the switch 44. According to the second embodiment, voltage output from the circuit generating the voltage of the plus side of the common electrode driver 20 is applied to the one input terminal (+) of the non-inverting amplifier 42 through a resistor 45. The other configuration in the second embodiment is the same as that in the first embodiment.

Next, operations of the field sequential liquid crystal display device 100a will be described with reference to FIGS. 4 to 6 and FIG. 9.

According to the second embodiment, as shown in FIG. 5, the voltage applied to the common electrode 233 is varied so that the amplitude of its pulse is increased more than the amplitude shown in FIG. 4, as in the first embodiment. That is, the voltage is increased more than the high voltage (High) and is decreased more than the low voltage (Low). In this way, the black voltage (which is the voltage in which a difference between the voltage applied to the pixel electrodes 232 and the common electrode 233 is the maximum) is changed. By increasing the black voltage of the red (R) light, the black voltage of the red (R) light shown in FIG. 6 is moved toward the blue (B) light. Likewise, by increasing the black voltage of the green (G) light, the black voltage of the green (G) light shown in FIG. 6 is moved toward the blue (B) light. In addition, the black voltages of the red (R), green (G), and blue (B) light are adjusted to be substantially equal to each other. At this time, the white voltage (which is voltage in which a difference between the voltage applied to the pixel electrodes 232 and the common electrode 233 is the minimum) is also changed to be increased. That is, the white voltages of the red (R) and green (G) light shown in FIG. 6 are also moved toward the high voltage. According to the second embodiment, voltage in which the transmissivity of the pixels 23 is the maximum refers to the white voltage. In addition, the transmissivity in the white voltage is not the maximum when the white voltage is moved. According to the second embodiment, as shown in FIG. 9, the voltage output from the circuit generating the voltage of the plus side of the common electrode driver 20 is applied to the one input terminal (+) of the non-inverting amplifier 42 through the resistor 45. With such a configuration, the voltage applied to the analog driver 15 is also increased by the non-inverting amplifier 42, thereby also increasing the voltage applied to the pixel electrodes 232. As a result, a difference of the voltage between the pixel electrodes 232 and the common electrode 233 is decreased, thereby decreasing the white voltage. In this way, the white voltage in which the transmissivity of the pixels 23 is the maximum is adjusted. According to the second embodiment, the transmissivities of the pixels 23 are adjusted to be substantially equal to each other in every color of the LEDs 27a to 27c, by varying the intensity of the voltage applied to the pixel electrodes 232 of the pixels 23 in every color of the LEDs 27a to 27c.

The other operations in the second embodiment are the same as those in the first embodiment.

According to the second embodiment, as described above, the black voltage of the pixels 23 is adjusted by varying the intensity of the voltage applied to the common electrode 233 of the pixels and the white voltage of the pixels 23 is also adjusted by varying the voltage applied to the pixel electrodes 232. In this way, the white voltage is adjusted so that the transmissivities of the colors of the LEDs 27a to 27c are substantially equal to each other. Accordingly, it is possible to display not only the black color but also the white color.

According to the second embodiment, as described above, the white voltage is the voltage in which the transmissivity of the pixels 23 is the maximum. The transmissivities of the pixels 23 in the colors of the LEDs 27a to 27c are adjusted to be substantially equal to each other by varying the intensities of the voltages applied to the pixel electrodes 232 of the pixels 23 in the colors of the LEDs 27a to 27c to be substantially equal one another in every color of the plurality of LEDs 27a to 27c. In this way, it is possible to display the white color using the red LED 27a, the green LED 27b, and the blue LED 27c.

According to the second embodiment, it is possible to easily vary the intensity of the voltage applied to the pixel electrodes 232 by adding the voltage applied to the common electrode 233 to the reference voltage and thus varying the intensity of the voltage applied to the pixel electrodes 232, as described above.

According to the second embodiment, it is possible to easily increase the voltage output from the non-inverting amplifier 42 by adding the voltage applied to the common electrode 233 to the reference voltage output to the non-inverting amplifier 42 with the non-inverting amplifier 42, as described above.

Other advantages of the second embodiment are the same as those of the first embodiment.

The embodiments put into practice are just exemplary of the invention and are not to be considered as limiting. The scope of the invention is not to be considered as limited by the foregoing description and is only limited by equivalent meanings and equivalent modifications of the scope of the appended claims.

For example, in the first and second embodiments, the LEDs are used as the light sources, but the invention is not limited thereto. For example, another light-emitting unit such as an organic EL may be used.

In the first and second embodiments, the LEDs radiating the red, green, and blue light are used, but the invention is not limited thereto. For example, LEDs radiating cyan, magenta, and yellow light may be used. Accordingly, it is possible to display a color image by additive color mixing.

In the first and second embodiments, the voltage (a difference between the voltage applied to the pixel electrodes and the voltage applied to the common electrode) applied to the liquid crystal is increased, but the invention is not limited thereto. For example, the voltage applied to the liquid crystal may be decreased.

In the first and second embodiments, the line inverse driving process as the process of driving the liquid crystal display device is used, but the invention is not limited thereto. For example, a dot inverse driving process may be used in addition to the line inverse driving process.

What is claimed is:

1. A liquid crystal display device comprising:
pixels which each include a liquid crystal, a pixel electrode, and a common electrode, the pixel electrode and the common electrode applying voltage to the liquid crystal;
a display unit in which the plurality of pixels are arranged in a matrix shape; and
a plurality of light sources,
wherein the voltage applied to the liquid crystal is adjusted by varying an intensity of voltage applied to the common electrode of the pixels in accordance with light radiated by the plurality of light sources.

2. The liquid crystal display device according to claim 1, wherein the intensity of the voltage applied to the common electrode of the pixels varies in each color of the plurality of light sources, so that transmissivities of a black display, where transmissivity of the pixels is the minimum, in the colors of the plurality of light sources are adjusted to be substantially equal to each other.

3. The liquid crystal display device according to claim 1, wherein the voltage applied to the common electrode is in a pulse state.

4. The liquid crystal display device according to claim 1, wherein the liquid crystal exhibits a bend alignment in which liquid crystal molecules of the liquid crystal are arranged like a bow shape when voltage for phase transition of the liquid crystal is applied.

5. The liquid crystal display device according to claim 1, wherein the pixels are of an inversion-driven type in which a polarity of the voltage applied to the liquid crystal is changed by varying the voltage applied to the common electrode of the pixels whenever the light sources radiating light are switched.

6. The liquid crystal display device according to claim 1, wherein respective colors radiated by the plurality of light sources are different colors selected from red, green, and blue.

7. The liquid crystal display device according to claim 1, wherein the intensity of voltage applied to the pixel electrodes of the pixels varies in each color of the plurality of light sources, so that the maximum transmissivities of the pixels in the colors of the plurality of light sources are adjusted to be substantially equal to each other.

8. The liquid crystal display device according to claim 7, further comprising:
a first circuit to which reference voltage is applied and which converts a digital image signal to an analog image signal and applies voltage to the pixel electrodes; and
a second circuit which is disposed between a power source generating the reference voltage and the first circuit,
wherein the intensity of the voltage applied to the pixel electrodes varies by adding the voltage applied to the common electrode to the reference voltage.

9. The liquid crystal display device according to claim 8, wherein the second circuit is composed of a non-inverting amplifier.

10. The liquid crystal display device according to claim 1, wherein the plurality of light sources are controlled by field sequential driving controlled to be turned on in order for every color.

11. A head-up display comprising the liquid crystal display device according to claim 1.
